(19) United States
(12) Patent Application Publication
(10) Pub. No.: US 2003/0071185 A1
(43) Pub. Date: Apr. 17, 2003

(54) Flag pole holder for trailer hitch

(76) Inventor: Joseph Casapulla, Newark, DE (US)

Correspondence Address: CONNOLLY BOVE LODGE & HUTZ, LLP, 1220 N MARKET STREET, P O BOX 2207, WILMINGTON, DE, 19899

(21) Appl. No.: 09/975,794

(22) Filed: Oct. 12, 2001

(51) Int. Cl. A01K 97/10

(52) U.S. Cl. 248/534

(57) ABSTRACT

A flag pole holder includes a generally tubular socket for receiving a flag pole that is attached, such as by welding, to a collar for engaging a trailer hitch drawbar. The collar has four sidewalls defining a generally rectangular or square cross-sectional opening and is mounted around the drawbar. The position of the collar is adjustable along the length of the drawbar, and the connection between the collar and the drawbar is held stably with a fastener, such as a bolt and wing nut or an allen set screw. When the collar of the flag pole holder is attached to the drawbar, it does not interfere with the ball hitch of a standard trailer hitch, and such ball hitch trailer hitch may still be used to tow a trailer or other item.

This invention relates to a flag pole holder for removably attaching to the hitch drawbar of a ball hitch trailer hitch.

### BACKGROUND OF THE INVENTION

Various means for attaching flags and flag pole holders to motor vehicles have been proposed in the art. U.S. Pat. No. 1,597,266 discloses a flag holder that has a clamp that engages a mud guard or another vertical surface on the exterior of the vehicle. A tubular socket is attached to the clamp. The flag pole fits within the tubular socket and a screw can be tightened to hold the pole within the socket.

U.S. Pat. No. 4,582,017 discloses a flag holder mounted to a bumper of a motor vehicle. The flag pole socket is attached to a clamp that tightens around the bumper when a wing nut is tightened.

U.S. Pat. No. 6,010,107 shows a flag holder attached to a clip that mounts to a motor vehicle window. The clip has ports to hold one or multiple small-sized flag poles.

Photographs of flag pole holders attached to trailer hitches are shown on two web-sites—flaghitch.com and hitchflag.com. The photograph at flaghitch.com shows a flag pole holder mounted to the ball of the ball hitch, thus preventing the user from towing a trailer or attaching any other item to the ball. The holder shown in the photographs at hitchflag.com show a special hitch drawbar that mates with the receiving portion of the standard rectangular cross-section trailer hitch. A cotter pin is provided to secure the drawbar in a desired position within the hitch. This special hitch drawbar also has a socket for receiving a flag pole, wherein the socket is welded to one exterior surface of the drawbar. This flag holder does not maintain the ball hitch, and thus also prevents the user from towing a trailer or attaching any other item to the trailer hitch.

Accordingly, the prior art does not show a universal means for attaching a flag pole holder to a standard ball hitch trailer hitch while also permitting the user to retain the option to tow a trailer or other tow-able item with that hitch.

### SUMMARY OF THE INVENTION

A flag pole holder has a socket for receiving a flag pole and a collar attached to the socket. The collar is removably mountable to a drawbar of a standard ball hitch-type trailer hitch. When mounted on the drawbar, the collar does not interfere with the ball hitch, so that the flag pole holder may be used even when a trailer or other towed item is hitched to the ball hitch for towing by the motor vehicle.

In a preferred embodiment, the collar has four side walls having inner and outer surfaces, with the inner surfaces of the side walls defining a cavity having generally square or rectangular cross-section. The collar slidably fits around the generally square or rectangular drawbar with its inner surfaces contacting the outer surfaces of the drawbar so as to attach the collar and socket combination forming the flag pole holder to the draw bar. The collar may be attached to the drawbar with one or more fasteners. When the drawbar has holes therethrough to facility attachment of the collar, exemplary fasteners include a bolt and wing nut combination or an allen set screw.

The socket preferably is welded to the exterior surface of one of the side walls of the collar. The socket further preferably has associated with it a fastener to variably tighten and loosen the contact between the flag pole and the socket when a flag pole is held within the socket. Exemplary fasteners include a thumb screw and a bolt. If the flag pole is telescopically engaged by the socket to permit the flag pole height to be variably adjusted, the fastener may be a collar clamp around the socket and the retractable flag pole.

### DESCRIPTION OF THE FIGURES

FIG. 1 is a side elevational view of a flag pole holder with a flag pole therein, said flag pole holder attached to a square cross-sectioned hitch drawbar of a ball hitch trailer hitch attached to a motor vehicle (the vehicle being shown in phantom outline), wherein the flag pole holder components and hitch components are also shown in phantom outline as detached from the vehicle;

FIG. 2 is a side elevational view of the flag pole holder with the flag pole broken away, showing the flag pole holder attached to the hitch drawbar, wherein the position of the flag pole holder with relation to the horizontal draw bar is adjustable to an alternate location along the draw bar as shown in phantom outline;

FIG. 3 is a left end elevational view of FIG. 2 showing the flag pole holder with flag pole broken away as mounted to the hitch drawbar;

FIG. 4 is a top plan view of FIG. 2 showing the flag pole holder with flag pole broken away and mounted to the hitch drawbar;

FIG. 5 is a side elevational view of the flag pole holder with a flag pole therein, said flag pole holder attached to a square cross-sectioned hitch drawbar of a ball hitch trailer hitch attached to a motor vehicle (the vehicle being shown in phantom outline), and wherein a boat trailer (shown in phantom outline) is attached to the ball of the ball hitch; and

FIG. 6 is a side elevational view showing an alternate embodiment of the flag pole holder wherein the flag pole telescopically slides into and out of the holder to permit variable height adjustment; and

FIG. 7 is a side elevational view of the flag pole holder positively secured to the hitch drawbar in an alternative manner.

### DESCRIPTION OF THE PREFERRED EMBODIMENTS

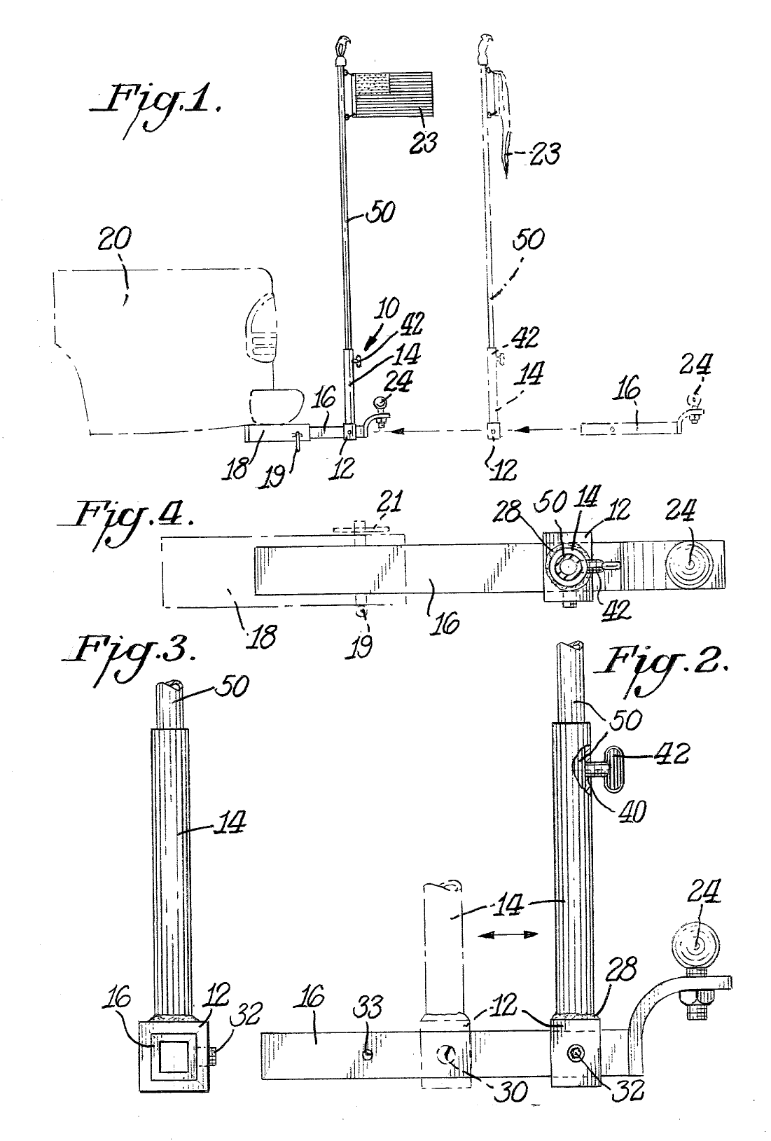

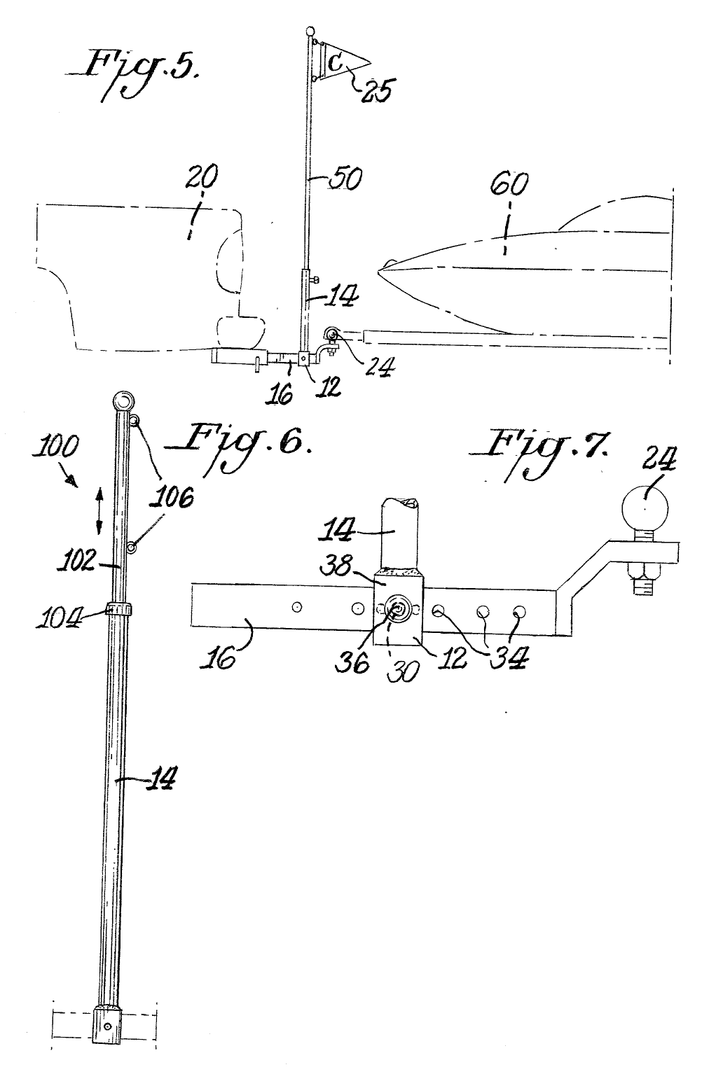

Referring first to FIG. 1 there is shown a flag pole holder 10 having a collar 12 slidably mounted onto a horizontal hitch drawbar 16 extending from a square hitch receiver 18 provided on a motor vehicle 20, and having a socket 14 for receiving a flag pole 50 attached to the collar 12, such as by welding. Preferably the collar and socket are fabricated from a metal, such as steel or aluminum, or any other material that will withstand tensile forces and weather to which the flag pole holder will be subjected. A ball hitch 24 is provided at the distal end of the drawbar 16, with the proximal end of such drawbar 16 inserted into the square hitch receiver 18. As shown in FIG. 1, the flag pole holder 10 is mounted onto the drawbar 16 by sliding the collar 12 over the drawbar 16 and then inserting the proximal end of the drawbar 16 into the square hitch receiver 18. The proximal end of the drawbar 16 engages the square hitch receiver 18 and is held in position with a cross pin 19 and associated spring clip 21 (see FIG. 4) The drawbar 16 has near its proximal end a retainer pin hole 33 for engagement with the cross pin 19.

The collar 12 has four side walls that define an inner cavity having a generally rectangular or square cross section (see FIG. 2). The socket 14 is attached to the exterior surface of one of the side walls such as by weld 28. At least one of the side walls of the collar 12 is provided with a hole 30 through which one or more fasteners may be inserted to engage the collar 12 to the drawbar 16. In FIG. 2 an allen screw 32 is inserted through the hole 30 in the collar 12 and tightened to contact the side wall of the drawbar to hold the collar 12 in place at one position along the length of the drawbar 16.

A flag 23 (FIG. 1) or pennant 25 (FIG. 5) or other banner is attached to the upper portion of the flag pole 50 with means generally known in the art. In FIGS. 1 and 5, the top of the flag pole is provided with hooks 22. Clips 27 are used to engage the hooks 22.

As shown in FIG. 7, the drawbar 16 is alternatively provided with retainer pin holes 34. The collar 12 may also be attached to the drawbar 16 using fasteners that engage both the hole 30 in the collar 12 and the holes 34 in the drawbar 16. In FIG. 7, the fasteners used are a bolt 36 and wing nut 38. The drawbar 16 may have a number of sleeve positioning holes 34 to engage the fasteners 36, 38 and hold the collar 12 in one position along the length of the drawbar 16.

In the preferred embodiment shown in FIG. 2 and FIG. 3, the socket 14 is generally tubular and is provided with its axis oriented generally perpendicularly to the exterior surface of the upper wall of the collar 12 from which the socket depends. Other socket orientations are possible, and it is also possible to have more than one socket associated with a collar. The proximal end of the socket 14 is welded to the exterior surface of the upper wall of the collar 12. Nearer to its distal end, the socket 14 has cut therethrough a hole 40 into which is inserted a thumb screw 42. By turning the thumb screw 42, the end of the screw 42 contacts a surface of the flag pole 50 held within the socket 14. This contact stabilizes the position of the pole 50 within the socket 14, thus maintaining the pole 50 within the socket 14.

The flag pole holder 10 has greater flexibility than the prior art flag holders for attachment to motor vehicles. While the flag pole holder 10 is attached to the drawbar 16, a trailer for towing a boat 60 or other item may be hitched to the ball hitch 24 (see FIG. 5)

The flag pole holder 10 may be used to hold flag poles of various dimensions. Referring next to FIG. 6, an alternate embodiment 100 of the flag pole holder of the invention is shown in which the flag pole 102 is an integral part. The flag pole 102 telescopically rises and lowers within the socket 14 to vary the height of the flag pole. A collar clamp 104 is provided at the distal end of the socket 14 for variably tightening and loosening the connection between the socket 14 and the pole 102. The pole 102 has hooks or eyelets 106 to permit a flag 23 or pennant 25 (FIG. 5) to be attached.

While the preferred embodiments are flag pole holders, the invention may also have application for attaching other accessories to the drawbar of a trailer hitch. Thus, the invention includes the collar associated with a mounting element for an accessory, which may include a flag, but could be another article such as a ski rack, a bicycle rack or luggage carrier.

The invention has been illustrated by detailed description and examples of the preferred embodiments. Various changes in form and detail will be within the skill of persons skilled in the art. Therefore, the invention must be measured by the claims and not by the description of the preferred embodiments.

I claim:

1. A flag pole holder, comprising:
a socket for receiving a flag pole;
a collar attached to the socket, said collar mountable to a trailer hitch drawbar for removably attaching said collar to said drawbar.

2. The flag pole holder of claim 1, wherein the socket is welded to the collar.

3. The flag pole holder of claim 1, further comprising a fastener associated with the socket to variably tighten and loosen contact between the flag pole and the socket when the flag pole is held within the socket.

4. The flag pole holder of claim 1, wherein the collar comprises four inner walls that define a generally square or rectangular inner cross-section.

5. The flag pole holder of claim 1, further comprising a fastener associated with the collar to variably tighten and loosen connection between the collar and the trailer hitch drawbar.

6. The flag pole holder of claim 5, wherein the fastener is a set screw.

7. The flag pole holder of claim 5, wherein the fastener is a combination of a bolt and a wing nut.

8. The flag pole holder of claim 3, wherein the fastener is a thumb screw.

9. The flag pole holder of claim 3, wherein the fastener is a bolt.

10. The flag pole holder of claim 1, further comprising a flag pole telescopically engaged by the socket.

11. The flag pole holder of claim 10, further comprising a collar clamp for tightening and loosening the connection between the flag pole and the socket to permit variably adjusting the height of the flag pole.

12. The flag pole holder of claim 10, further comprising means for attaching a flag or pennant to the flag pole.

13. A holder for attaching an accessory to a drawbar of a trailer hitch, comprising:
a collar removably mountable to the drawbar of the trailer hitch, said collar having four side walls that define an inner cavity with a square or rectangular cross-section;
a fastener associated with the collar to variably tighten and loosen connection between the collar and the drawbar; and
a mounting element with a means for engaging the accessory, said mounting element being attached to the collar.

14. The holder of claim 13, wherein the accessory is a flag or pennant.

15. The holder of claim 13, wherein the mounting element is a socket for receiving an accessory with a generally tubular cross section.

16. The holder of claim 13, wherein the mounting element is attached to the collar by welding.

17. The holder of claim 13, wherein the mounting element is a socket for receiving an accessory with a generally tubular cross section and the means for engaging the accessory is a fastener.

18. A holder for attaching an accessory to a trailer hitch concurrently when said trailer hitch is engaged to tow a trailer, comprising:
a drawbar having a proximal end and a distal end, with the proximal end insertable into a hitch receiver provided on a motor vehicle and with a ball hitch provided at the distal end for connecting the trailer for towing, said drawbar having one or more outer surfaces defining a geometric cross-sectional shape;
a collar removably mountable to the drawbar, said collar defining an inner cavity having a cross-sectional shape complementary to the cross-sectional shape of the drawbar;
a fastener associated with the collar to variably tighten and loosen connection between the collar and the drawbar; and
a mounting element with a means for engaging the accessory, said mounting element being attached to the collar.

19. The holder of claim 18, wherein the accessory is a flag or pennant.

20. The holder of claim 18, wherein the drawbar has a rectangular or square cross-sectional shape.
